(19) United States
(12) Patent Application Publication
(10) Pub. No.: US 2020/0100601 A1
(43) Pub. Date: Apr. 2, 2020

(54) GAS SPRING DEVICE FOR ADJUSTING THE HEIGHT OF AN OFFICE CHAIR

(71) Applicant: LOGICDATA Electronic & Software Entwicklungs GmbH, Deutschlandsberg (AT)

(72) Inventors: Stefan LUKAS, Preding (AT); Thomas NEGER-LOIBNER, Graz (AT); Richard HALATSCHEK, Poelfing-Brunn (AT)

(21) Appl. No.: 15/999,600

(22) PCT Filed: Feb. 17, 2017
(86) PCT No.: PCT/EP2017/053708

§ 371 Date: Aug. 17, 2018

(30) Foreign Application Priority Data
Feb. 18, 2016 (DE) 10 2016 102 891.6

(51) Int. Cl. A47C 31/12; A47C 3/30; A47C 3/22; A47C 31/00; G05B 19/416

(52) U.S. Cl. CPC A47C 31/126; A47C 3/30; G05B 2219/40175; A47C 31/008; G05B 19/416; A47C 3/22

(57) ABSTRACT

A gas spring device of an office chair has a gas spring for height adjustment by means of a movable component and at least one sensor element, which is configured to detect a load and to generate a sensor signal depending on the detected load. In addition, the gas spring device has an electronic circuit adapted to generate user data depending on the at least one sensor signal. The user data represents one or more facts about the usage of the office chair. The at least one sensor element has at least one position sensor which is configured to detect a position of the movable component and to generate a position signal depending on the detected position.

### BACKGROUND OF THE INVENTION

The present disclosure concerns a gas spring device for adjusting the height of an office or work chair.

Office chairs offer various options for adjusting the seat height, the height of armrests, the inclination of the backrest, the inclination of the seat surface and so on, depending on the design. A gas spring, for example, can be used for height adjustment.

In order to improve the use of the office chair, for example with regard to aspects of workplace ergonomics, in particular to optimize the posture and/or sitting position of a user, it may be desirable for the user to record and evaluate the way in which the office chair is used.

### SUMMARY OF THE INVENTION

The present disclosure provides an improved concept for a gas spring device for adjusting the height of an office chair, which allows the user to record and/or evaluate the way in which the office chair is used in a particularly efficient manner.

According to the improved concept, a gas spring device for height adjustment of an office chair comprises at least one sensor device for detecting a load as well as an electronic circuit in addition to the actual gas spring. By processing one or more sensor signals through the circuit, usage data of the office chair are generated. These can be evaluated by the circuit and/or external receivers to optimize the use of the office chair, for example.

According to the improved concept, a gas spring device for height adjustment of an office chair is specified. The gas spring device has a gas spring which is arranged and equipped to adjust the height of the office chair by means of a movable component of the gas spring. The gas spring device also has at least one sensor element arranged on the gas spring device, which is arranged to detect a load on the gas spring device and to generate at least one sensor signal depending on the detected load. In addition, the gas spring device has an electronic circuit arranged to generate usage data depending on the at least one sensor signal. The usage data represents one or more facts about the use of the office chair.

The gas spring device, in particular the gas spring, can be arranged, for example, between a seat surface and a base, also known as a spider or foot spider, of the office chair. For example, the gas spring contains a piston and a cylinder, whereby the piston in the cylinder can be moved along a longitudinal axis of the gas spring to adjust the seat height of the office chair. To fix the seat height, the penetration depth of the piston into the cylinder can be fixed, for example. In this state, for example, the gas spring is used as a spring for damping. The gas spring has a spring constant or effective spring constant, which is determined, for example, by the internal pressure of a gas inside the cylinder of the gas spring. This can, for example, cushion changes in the load on the seat surface of the office chair, especially-when a user sits down on the seat surface.

The longitudinal axis of the gas spring corresponds to an axis along a direction of movement of the gas spring, in particular the movable component of the gas spring, for adjusting the height of the office chair.

In various embodiments, the gas spring device comprises a housing that can be attached to the base or the seat surface of the office chair, for example. The piston of the gas spring is fixed to the housing with respect to the housing, while the cylinder is movable along the longitudinal axis with respect to the housing and dips more or less deeply into the housing. In such designs, the cylinder is a movable component of the gas spring, while the piston is an immovable component of the gas spring. Alternatively, the cylinder can also be fixed to the housing with respect to the housing and the piston can be movable with respect to the housing and immerse more or less deeply into the housing. In such designs, the piston represents the movable component of the gas spring, while the cylinder represents the immovable component of the gas spring.

It is emphasized that the term “immovable” refers only to a direction of movement along the longitudinal axis of the gas spring. Thus, a rotational movement of the immovable component with respect to the housing is not excluded. The moving component, on the other hand, is movable along its longitudinal axis. In addition, the moving component can also be movable with respect to rotation.

For example, the housing can be connected to the base via a first cone and the movable component to the seat surface of the office chair via a second cone or vice versa. The housing can also be used to guide the moving component of the gas spring.

According to the various embodiments of the gas spring device, the circuit is arranged inside or on the housing. In some embodiments, the circuit is mounted on the inside of the housing or on the moving component.

The usage data generated by the circuit can be used to evaluate the user's usage behavior. This makes it possible to optimize the use of the office chair, particularly with regard to ergonomic aspects.

Applications for the improved concept can include not only the provision of data to optimize a user's posture and/or sitting position with regard to use in a desk chair, but also the following: User presence detection, user activity tracking, fail-use detection, use as an input device for computers, for example as a so-called “body joystick” or “body controller” for computer games, generation of statistical data for the further development of office chairs. Further application possibilities are of course not excluded.

In addition to force and position measurements, the results of which are aimed at improving workplace ergonomics, other data could also be recorded with the help of this invention by using the respective sensors, which also contribute to the health or well-being of the user. Examples include measurements of noise, brightness, oxygen, CO2, humidity, temperature, acceleration or measurements with other environmental sensors.

In various embodiments, the at least one sensor element has at least one position sensor which is designed to detect a position of the moveable component and to generate a position signal depending on the detected position.

In various embodiments, the at least one position sensor contains an incremental measuring sensor, a direct measuring sensor, a magnetic sensor, a Hall sensor, a capacitive sensor and/or an optical sensor. The position can also be measured resistively, e.g. via a potentiometer in combination with a gear which converts a linear movement into a rotary movement, a linear potentiometer and/or coding, e.g. a Grey Code.

In an embodiment, the gas spring device further comprises a spring body disposed between a portion of the movable component and a force sensor enclosed by the position sensor. The force sensor is set up to detect a force which acts on the force sensor from the spring body in the direction of a longitudinal axis of the gas spring and to generate a force signal depending on the detected force. The circuit is designed to generate the position signal depending on the force signal.

For example, the force sensor has a deformation body on which the spring body is supported. At least one deformation sensor is mounted on the deformation body and is designed to generate the force signal as a function of a detected deformation of the deformation body. The spring body can comprise a spiral spring.

In various embodiments, the circuit is designed to generate height data representing a height adjustment of the gas spring or office chair, depending on the position signal.

By means of the height data and the height setting represented by it, the usage behavior can be further recorded and optimized.

In various embodiments, the circuit is designed to determine a force acting on the gas spring in the direction of the longitudinal axis of the gas spring based on a change in the position signal and a spring constant of the gas spring. The circuit is also designed to generate additional weight data representing the body weight of an office chair user depending on the determined force.

The change of the position signal is, for example, due to a change of the position of the movable component while a height adjustment is not possible or deactivated. The change in position of the movable component can result, for example, from a user sitting on the office chair. The force acting on the gas spring in the direction of the longitudinal axis of the gas spring can, for example, be determined as the product of the spring constant of the gas spring and a path corresponding to the change in position of the moving component.

In various embodiments of the gas spring device, the position sensor comprises at least one combination of at least one conductive surface and an associated slider formed between a fixed part of the gas spring device and the movable component. This allows both resistive measurements according to the principle of a potentiometer and measurements in which the result depends on a contact or conductivity between the conductive surface and the slider. The principle can be used to determine both an axial position and a radial position.

For example, the combination comprises at least one potentiometer with a resistive surface as the conductive surface and the associated slider. The circuit is designed to generate the position signal depending on the resistance of the at least one potentiometer.

The at least one potentiometer can be formed parallel to a longitudinal axis of the gas spring and can be arranged between an inside of the housing of the gas spring device and the movable component. In this case, the position signal includes an axial position.

Alternatively or additionally, the at least one potentiometer can be designed as an angle potentiometer which is formed circular to a longitudinal axis of the gas spring with a circular or circular segment shaped resistive surface and with the associated slider. Either this resistive surface or the associated slider are arranged so that they cannot rotate relative to a housing of the gas spring device. In this case, the position signal includes a radial position.

In this radial measurement, the rotationally fixed part of the angle potentiometer cannot be displaceably arranged in the housing relative to the longitudinal axis. In other words, this part does not change its axial position within the gas spring arrangement.

Alternatively, the rotationally fixed part of the angle potentiometer can be arranged so that it can be displaced relative to the longitudinal axis in the housing so that it can be displaced along the longitudinal axis of the gas spring arrangement. For example, a special adapter is attached to the cylinder of the gas spring, which moves the radial resistance tracks with the cylinder. For example, the position sensor comprises a further combination of a further conductive surface and a corresponding slider, whereby the further combination is set up for transmitting the position signal. Thus, for example, the position signal or the signal from the radial resistance paths can be transmitted from the adapter to the outside.

In radial measurements, the position sensor can include an element, in particular a tube, for transmitting a rotary movement of the gas spring to either the resistive surface of the angle potentiometer or the associated slider.

In other embodiments with at least one conductive surface and associated slider, for example, the combination comprises at least one strip with at least one conductive surface and at least one non-conductive surface for binary coding. Each path has its own grinder. The circuit is set up to generate the position signal as a function of a conductivity between the at least one path and the associated slider.

With only one path, only two different states can be detected according to the binary principle, corresponding to an angular range of 180° with a violent division. However, as soon as several such paths are used with an associated grinder, a larger number of states can also be detected by the binary combinations. The other strips each have several conductive and non-conductive surfaces according to their significance.

For example, the at least one path is arranged parallel to a longitudinal axis of the gas spring, the position signal in this case comprising an axial position.

Alternatively or additionally, the at least one path runs circularly to a longitudinal axis of the gas spring with a circular or circular segment shape. Either the at least one path or the associated slider are arranged rotationally fixed with respect to a housing of the gas spring device. In this case, the position signal includes a radial position.

In various designs of the gas spring device, the movable component comprises a piston and a longitudinally displaceable cylinder, which are coupled to each other in a rotationally fixed manner. The position sensor comprises an angle sensor that detects an angular position of the cylinder. In this case, the position signal includes a radial position.

For example, the angle sensor comprises a coding disk or a magnet with at least one Hall sensor, in particular at least two Hall sensors.

In various embodiments of the gas spring device, the movable component comprises a piston and a longitudinally displaceable cylinder. An end face of the cylinder forms a reflector surface which, distributed over a circumference of the cylinder in the direction of a longitudinal axis of the gas spring, has a defined varying extension with respect to a normal to the longitudinal axis. The position sensor comprises a first and at least one second distance sensor which are fixedly mounted in a housing of the gas spring device and are arranged to detect a first and second distance to the reflector surface. The circuit is set up to generate the position signal depending on the first and second distance.

The defined varying extension is based, for example, on a sine curve. For example, in the case of a theoretical unwinding of the cylindrical surface, i.e. the representation in the plane, the defined varying extension results.

In various configurations, the circuit is designed to generate the position signal based on a sum of the first and second distances, for example averaging, with an axial position and/or based on a difference of the first and second distances with a radial position.

The distance sensors can be designed as optical sensors based on infrared and/or laser radiation or as ultrasonic sensors.

In various embodiments of the gas spring device, the position sensor is designed to determine a resonance frequency of a vacant space in the housing to the movable component. The circuit is set up to generate the position signal depending on the determined resonance frequency. In this case, the position signal includes an axial position.

The vacant space results, for example, from the housing volume less the volume that is used by the movable component, i.e. cylinder and piston, within the housing.

In different embodiments of the gas spring device, the position sensor has a first conductive surface arranged or formed on an inner side of a housing of the gas spring device and a second conductive surface arranged or formed on an outer side of the component movable in the housing. A capacitive arrangement is formed by the first and second conductive surfaces. The circuit is designed to generate the position signal depending on a capacitance value of the capacitive arrangement. In this case, the position signal includes an axial position.

The first and second conductive surfaces can be formed directly through the inside of the housing or the outside of the gas spring or movable component itself. An attachment of separate guide surfaces at one or both points is therefore not absolutely necessary but still possible.

Due to the displacement of the movable component, in particular the cylinder, on the outside of which the second conductive surface is preferably formed, the capacitance ratios between the two conductive surfaces, which act as capacitor electrodes, change. The axial position can be determined on the basis of known geometric properties.

In various implementations of the gas spring device, the at least one sensor element has a force sensor which is designed to detect a force acting on the gas spring in the direction of the longitudinal axis of the gas spring and to generate a force signal depending on the detected force. For example, the circuit is designed to generate weight data representing the body weight of a user of the office chair, depending on the force signal.

In various implementations, the force sensor contains one or more strain gauges and/or one or more piezo sensors, especially piezoelectric sensors.

In various implementations, the force sensor is arranged on the fixed component of the gas spring, for example the piston or the cylinder. For example, the force sensor may be located between the immovable component and the housing, between the immovable component and the base or between the immovable component and the seat surface.

In various implementations of the gas spring device, the at least one sensor element has at least one deformation sensor which is designed to detect a deformation of the gas spring device and/or the gas spring and to generate a deformation signal depending on the detected deformation. For example, the circuit is designed to generate center of gravity data representing a position of a center of gravity of a user of the office chair, depending on the deformation signal.

The user's center of gravity can be changed, for example, by shifting the user's weight on the seat surface or by changing the inclination of the seat surface, the inclination of the backrest of the office chair or another adjustment of a component of the office chair.

In various implementations, the deformation sensor is set up to detect a deformation, in particular a bend, of the gas spring, of the piston, of the cylinder and/or of the housing and to generate the deformation signal depending on this.

In various implementations, the at least one strain sensor contains one or more strain gauges which are arranged on the gas spring, in particular on the piston and/or the cylinder, or on an inside or outside of the housing.

In various designs, the at least one sensor element comprises both the at least one deformation sensor and the force sensor. The circuit is designed to generate the center of gravity data as a function of the deformation signal and the force signal.

By means of the weight data and/or the center of gravity data, the usage behavior can be recorded and evaluated.

In various embodiments, the at least one deformation sensor is arranged on the gas spring, in particular on the piston or the cylinder, and is designed to detect a deformation of the gas spring, in particular of the piston or the cylinder, and to generate the deformation signal depending on the detected deformation of the gas spring.

In various embodiments, the at least one sensor element comprises a deformation body which is arranged at least in part between the gas spring device and a seat surface of the office chair. The at least one deformation sensor is arranged on the deformation body and is designed to detect a deformation of the deformation body and to generate the deformation signal depending on the detected deformation of the deformation body.

Alternatively, the deformation body can be arranged at least partially between the gas spring device and a base of the office chair.

The at least one strain sensor contains, for example, one or more strain gauges and/or one or more piezoelectric sensors which are arranged on the deformation body.

In various embodiments, the at least one deformation sensor is designed to detect a force acting on the deformation body in the direction of the longitudinal axis of the gas spring and to generate a further force signal depending on the force acting on the deformation body. The circuit is designed to generate first additional weight data representing the body weight of the user of the office chair, depending on the further force signal.

With advantage, both the body weight and the user's center of gravity can be determined with the help of the deformation body.

In various embodiments of the gas spring device, the gas spring device features an energy harvesting device which is designed to harvest electrical energy from a movement of the gas spring, in particular a movable component of the gas spring, for example the piston or the cylinder. The circuit is connected to the energy harvesting device to supply power to the circuit. In such designs, the principle of “energy harvesting” is thus implemented in a gas spring device for adjusting the height of an office chair.

In various embodiments, the energy harvesting device includes an energy store for storing the energy obtained and the circuit is connected to the energy store or contains the energy store for supplying power to the circuit.

In various embodiments, the energy harvesting device includes at least one piezoelectric element which is arranged on the gas spring device, in particular on the gas spring or the housing, and is designed to harvest the electrical energy from the movement of the gas spring.

The at least one piezoelectric element of the energy harvesting device is arranged, for example, between the gas spring and the housing or between the housing and the office chair, in particular the base or the seat surface, or between the gas spring device and the office chair, in particular the base or the seat surface.

In configurations in which the force sensor contains one or more piezo sensors, for example, a piezo sensor of the force sensor can be used as a piezoelectric element of the energy harvesting device.

In various embodiments, the energy harvesting device is designed to harvest electrical energy from a movement of the gas spring along the longitudinal axis of the gas spring. Alternatively or additionally, the energy harvesting device is designed to harvest the electrical energy from a rotational movement of the gas spring. For example, a rotational movement of the gas spring designates a rotational movement with the longitudinal axis of the gas spring as an axis of rotation.

In various designs of the gas spring device, the energy harvesting device has at least one coil and at least one permanent magnet. The at least one coil or the at least one permanent magnet is attached to the movable component of the gas spring.

In different designs, the at least one coil and the at least one permanent magnet are arranged and aligned with respect to one another in such a way that a magnetic flux generated by the at least one permanent magnet varies through the at least one coil when the movable component moves, in particular varies in time.

The movement of the movable component can be a movement along the longitudinal axis or a rotary movement. The movement along the longitudinal axis can be caused, for example, by a height adjustment. Alternatively or additionally, the movement along the longitudinal axis can be caused by a damping movement of the moving component, for example when a user sits down on the office chair. The rotational movement can be caused, for example, by a rotary movement of the office chair, especially the seat surface.

In such embodiments, the effect of electromagnetic induction is used to induce a voltage in the coil and, for example, to charge the energy store of the energy harvesting device by means of a current generated by the induced voltage.

The at least one coil has one or more windings. In various embodiments, the coil is movably arranged relative to the at least one permanent magnet or the at least one permanent magnet is movably arranged relative to the coil. Depending on the orientation of the coil and the permanent magnet, a magnetic flux through the coil changes during the movement of the coil or of the at least one permanent magnet, whereby the voltage is induced electromagnetically.

In various embodiments, both the permanent magnet and the coil are movably arranged and the gas spring device also contains a magnetically conductive or ferromagnetic component, which is immovably arranged in the gas spring device. The magnetically conductive or ferromagnetic component has first areas located at a first distance from the longitudinal axis of the gas spring and second areas located at a second distance from the longitudinal axis of the gas spring. The second distance is larger than the first distance.

When the at least one permanent magnet and the coil move along the longitudinal axis of the gas spring, a distance between the at least one permanent magnet and the magnetically conductive or ferromagnetic component changes. Consequently, a magnetic flux density also changes along a movement of the coil and thus a magnetic flux through the coil during the movement of the coil. As a result, a voltage is induced by electromagnetic induction, which generates a current to charge the energy store.

In various embodiments, the at least one coil and the at least one permanent magnet are arranged on the movable component of the gas spring and the magnetically conductive or ferromagnetic component is immovably arranged in the housing of the gas spring device. Alternatively, the magnetically conductive or ferromagnetic component may be fixed to the movable component of the gas spring and the at least one coil and the at least one permanent magnet may be fixed in the gas spring device.

In various embodiments, a sign or polarity of the induced voltage changes during the movement of the moving component. In such designs, the circuit has a rectifier circuit which is designed to rectify the induced voltage or the current generated thereby to charge the energy store.

The change in the sign or polarity of the voltage is, for example, due to a change in the direction of the magnetic flux density with respect to a surface spanned by the at least one coil, in particular a winding plane of the at least one coil, or a winding axis of the at least one coil. Alternatively or additionally, the change in the sign or the polarity of the voltage can be caused by a change in the direction of movement of the moving component.

In various embodiments, the at least one permanent magnet has at least one radially magnetized annular first permanent magnet arranged around the movable component of the gas spring.

In various embodiments, a first coil of the at least one coil is firmly connected to the movable component, so that the first coil is moved along with it when the movable component moves in the direction of the longitudinal axis of the gas spring. The at least one first permanent magnet is fixed in the gas spring device.

In various embodiments, the windings of the first coil run around the movable component of the gas spring. The movable component and the first coil are located in an inner area, in particular within an inner radius of the at least one first permanent magnet.

In various embodiments, the at least one first permanent magnet is permanently connected to the movable component, so that the at least one first permanent magnet is moved along with a movement of the movable component in the direction of the longitudinal axis of the gas spring and the first coil is arranged fixedly in the gas spring device.

The windings of the first coil run around the moving component of the gas spring and around the at least one first permanent magnet.

The movable component is then located, for example, in the interior, whereas the first coil is located in an exterior area, especially outside an exterior radius, of at least one first permanent magnet.

In various embodiments; the winding axis of the first coil, a symmetry axis of the at least one first permanent magnet and the longitudinal axis of the gas spring coincide in particular.

In various embodiments, the at least one permanent magnet has two or more radially magnetized annular first permanent magnets. The two or more first permanent magnets are arranged relative to each other in such a way that their axes of symmetry coincide. For example, the two or more first permanent magnets are arranged one above the other, whereby there may be a distance or no distance between adjacent of the two or more first permanent magnets.

In various embodiments, the two or more first permanent magnets are alternately magnetized. Neighboring of the two or more first permanent magnets have opposite magnetic poles on their respective radial insides and opposite magnetic poles on their respective radial outsides.

By using two or more first permanent magnets, a range of motion of the movable component in which the voltage is induced is increased, for example. Furthermore, a greater inhomogeneity of the magnetic flux density generated by the at least one permanent magnet can be achieved, which in turn can lead to an increased induced voltage.

In various embodiments, the at least one permanent magnet has at least one second permanent magnet. The at least one second permanent magnet has a magnetization which lies at least partially in a plane perpendicular to the longitudinal axis of the gas spring.

In various embodiments, a second coil of the at least one coil is fixedly connected to the movable component of the gas spring, so that the second coil is moved along with a rotational movement of the movable component and the at least one second permanent magnet is fixedly arranged in the gas spring device.

The rotational movement of the second coil changes an angle of a direction of the magnetic flux density generated by the at least one second permanent magnet with respect to a winding plane or a winding axis of the second coil. This changes the magnetic flux through the second coil during a rotational movement of the movable component and the second coil. As a result, electromagnetic induction induces a voltage in the coil which can generate a current to charge the energy store.

In various embodiments, the at least one second permanent magnet is permanently connected to the movable component, so that the at least one second permanent magnet is moved along with the rotary movement of the movable component. The second coil is then fixed with the gas spring device.

In various embodiments, the winding axis of the first coil, especially during the rotational movement, lies in a plane on which the longitudinal axis of the gas spring is perpendicular.

In various embodiments, the at least one sensor element comprises at least one further position sensor which is arranged to detect a position of the movable component based on a spatial inhomogeneity of the magnetic flux density generated by the at least one permanent magnet and to generate a further position signal depending on the detected position. The circuit is designed to generate additional height data representing a height setting of the gas spring or office chair, depending on the further position signal.

For example, the at least one further position sensor can have at least one Hall sensor. The at least one Hall sensor is designed to detect the spatial inhomogeneity of the flux density of the at least one permanent magnet. For example, conclusions can be drawn about the position of the movable component and about the height setting of the gas spring or office chair.

With advantage, both the determination of further height data and thus the height setting of the gas spring or the office chair as well as the energy harvesting by means of the energy harvesting device with the same at least one permanent magnet can be achieved.

In various embodiments, the energy harvesting device comprises an electric generator and a transmission device, for example a gearbox. The transmission device is connected on the driven side to the housing of the gas spring device and on the driving side to a drive shaft of the generator. The transmission device is arranged and designed to convert a rotary movement of the movable component into a rotary movement of the drive shaft.

A transmission ratio of the transmission device is such that a speed of the rotational movement of the drive shaft is greater than a speed of the rotational movement of the movable component.

The connection of the transmission device to the housing can, for example, be formed via a gear wheel of the transmission device and a toothing on an inner side of the housing.

The electrical energy generated by the electrical generator is used to power the circuit and/or charge the energy storage device.

In various embodiments, the gas spring device has a wake-up element designed to signal the start of use of the gas spring device or office chair, in particular, to switch on the circuit from a standby state. For example, the wake-up element is formed by a piezoelectric element which is mounted between an end plate and an axial bearing of the gas spring device and emits a corresponding voltage pulse when pressurized, which can be evaluated by the circuit. For example, if the circuit is not used for a longer period of time, it goes into standby mode.

In various embodiments, the circuit comprises a communication interface which is equipped for wireless transmission of the user data, in particular the weight data, the center of gravity data, the first further weight data, the second further weight data, the height data and/or the further height data, to at least one external receiver.

Wireless transmission of user data can take place via Bluetooth, WLAN, GSM-based technology, radio technology such as Zigbee, RF or RFID, or another transmission technology.

The at least one external receiver can contain office equipment such as a table, air conditioning, room lighting or table lighting. The office equipment can then be controlled, for example, depending on the usage data, in particular depending on the usage behavior.

The at least one external receiver can alternatively or additionally contain a computer or a server. The computer or server can be used to evaluate the usage data or the usage behavior.

The at least one external receiver can alternatively or additionally include a display unit, such as a screen, a display, a smartphone, a tablet computer. This allows the user of the office chair, for example, to document, check and/or adapt the usage behavior.

In various embodiments, the gas spring device, in particular the gas spring, for example the movable component of the gas spring, includes a plug connector, in particular a plug or a socket for a plug connection, which is designed to electrically connect the gas spring device, in particular the circuit, with other electronic components of the office chair.

Other electronic components may include, for example, other sensor elements, input devices, keys, display devices and/or signal transmitters.

By connecting the other electronic components to the circuit of the gas spring device, data generated by the other electronic components can be transmitted to the circuit. For example, the data generated by the other electronic components can then be transmitted wirelessly to the at least one external receiver via the communication interface of the circuit.

According to the improved concept, an office chair with a gas spring device for height adjustment of the office chair is also described. The gas spring device is designed according to the improved concept of the gas spring device.

### BRIEF DESCRIPTION OF THE DRAWINGS

In the following, the invention is explained in detail on the basis of exemplary implementation forms with reference to the drawings. Components that are functionally identical or have an identical effect can have identical reference signs. Identical components or components with identical functions may be explained only in terms of the figure in which they appear first. The explanation is not necessarily repeated in the following figures.

In the drawings:

FIG. 1 shows an office chair with a gas spring device;

FIGS. 2A and 2B show a cross-section of an exemplary design of a gas spring device according to the improved concept;

FIG. 3 shows another representation of an office chair with a gas spring device;

FIG. 4 shows a cross-section of another exemplary design of a gas spring device according to the improved concept;

FIG. 5 shows a cross-section of another example implementation of a gas spring device according to the improved concept;

FIG. 6 shows a cross-section of another example implementation of a gas spring device according to the improved concept;

FIG. 7 shows a cross-section of another example implementation of a gas spring device according to the improved concept;

FIG. 8 is an example implementation of a position measurement for a gas spring device according to the improved concept;

FIG. 9 shows a cross-section of another example implementation of a gas spring device according to the improved concept;

FIGS. 10A and 10B an example implementation of a position measurement for a gas spring device according to the improved concept;

FIG. 11 shows a cross-section of another example implementation of a gas spring device according to the improved concept;

FIG. 12 shows a cross-section of another example implementation of a gas spring device according to the improved concept;

FIG. 13A shows a cross-section of another example implementation of a gas spring device according to the improved concept;

FIG. 13B is an example implementation of a permanent magnet arrangement for use in a gas spring device according to the improved concept;

FIG. 13C is another example implementation of a permanent magnet assembly for use in a gas spring device according to the improved concept; and

FIG. 14 is another example implementation of a permanent magnet arrangement for use in a gas spring device according to the improved concept.

### DETAILED DESCRIPTION

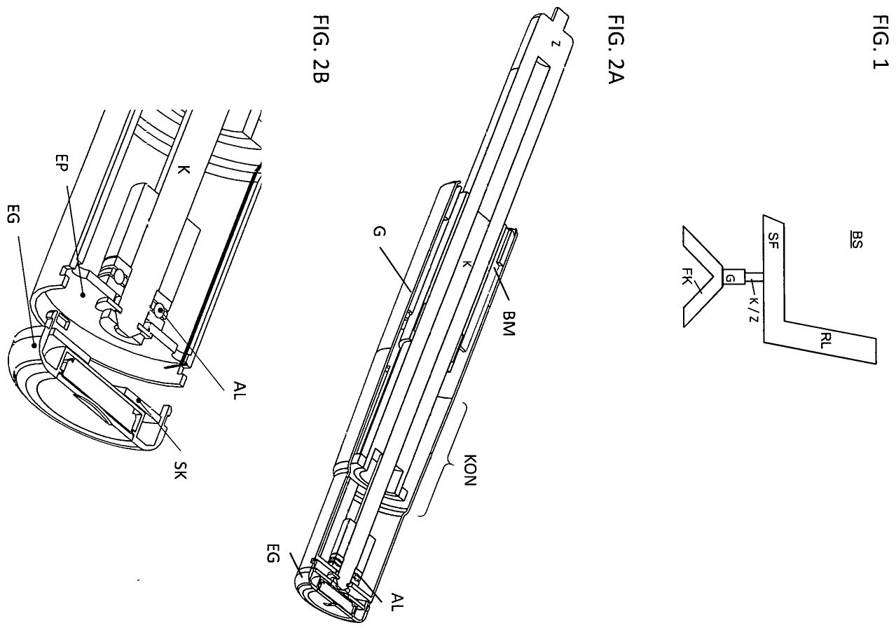

FIG. 1 shows a work chair BS with a gas spring device, for example a gas spring device according to the improved concept. The work chair BS has a seat surface SF, a backrest RL connected to the seat surface SF and a base FK.

In addition, the work chair BS comprises a gas spring device, which includes a housing G and a gas spring with a piston K and a cylinder Z, for example. In the example in FIG. 1, the housing G of the gas spring device is connected to the base FK of the work chair BS via a cone (not shown). In addition, the piston K or the cylinder Z is connected to the seat surface SF of the work chair BS via a cone (not shown).

The gas spring, for example, is an adjustable gas spring that is designed to adjust the seat height of the work chair BS, especially the seat surface SF. Optionally, an inclination of the seat surface SF and/or the backrest RL.

FIG. 2A and FIG. 2B show an exemplary sectional view of a design of a gas spring device according to the improved concept. The gas spring device contains a housing G, which can be connected to the base FK of the work chair BS in the area of a cone KON. Furthermore, the gas spring device comprises a gas spring with a cylinder Z and a piston K. The piston K can also be called a piston rod. In the example shown, for example, the piston K is permanently connected to the housing G via an axial bearing AL. The cylinder Z is mounted or fastened in the housing G by means of a BM fastener. This BM fastener acts as a guide element for cylinder Z in housing G.

In FIG. 2B the area of the gas spring device around the end plate EP is shown enlarged in an exploded view. It becomes clearer that the thrust bearing AL is designed as a ball bearing. A circuit SK is arranged in an electronic housing EG. Circuit SK, for example, can contain a circuit board or printed circuit board on which electronic components and/or integrated circuits are arranged and, if necessary, interconnected.

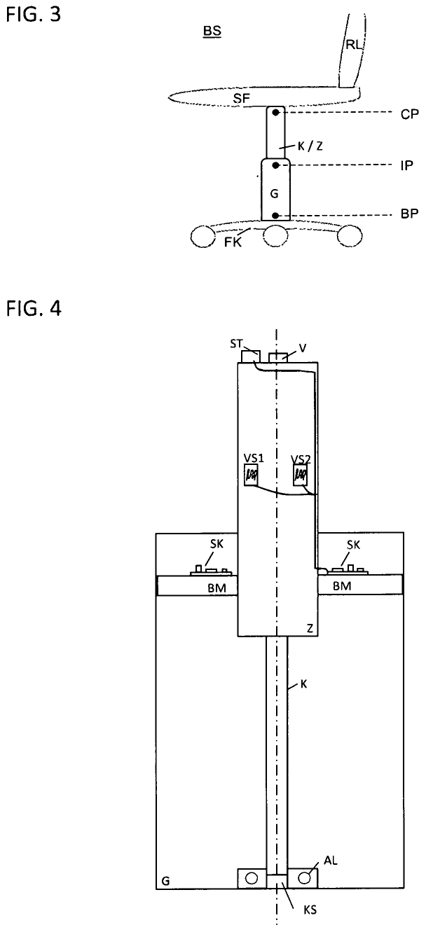

FIG. 3 shows another representation of an office chair BS with the gas spring device, which is based on the representation of FIG. 1. Various positions are shown at which a force measurement can be carried out, for example. One of these points is, for example, the connection point CP between the chair and the gas spring device. It is also possible to measure the force at the connection point BP between the gas spring device and the base FK. Alternatively or additionally, a force measurement can also be carried out within the gas spring device, marked by the point IP.

FIG. 4 shows a cross-section of an exemplary design of a gas spring device according to the improved concept, especially for use in an office chair BS, as shown in FIG. 1 or FIG. 3.

The gas spring device comprises a housing G, which, for example, is connected via a first cone to the base FK of the work chair BS. In addition, the gas spring device comprises a gas spring with a cylinder Z and a piston K. In the example shown, for example, the piston K is fixedly connected to the housing G. The cylinder Z, for example, is connected to the seat surface SF of the work chair BS via a second cone. With fixed housing G and piston K, cylinder Z can move along a longitudinal axis of the gas spring, for example to adjust the height of the seat surface SF and/or to cushion the seat surface SF, for example when a user sits down on the work chair BS. The longitudinal axis of the gas spring is indicated by a semi-dotted line in FIG. 4. In addition to the movement along the longitudinal axis, the gas spring, in particular the cylinder and/or piston K, can be rotationally movable to allow the seat surface SF of the work chair BS to rotate.

The gas spring has, for example, an adjustment element V on cylinder Z. If the adjustment element V is actuated, for example by a lever (not shown) which can be actuated by the user of the office chair, a movement of the cylinder Z along the longitudinal axis of the gas spring is released for height adjustment of the seat surface SF. If the adjustment element V is not actuated, the cylinder is locked, so that a height adjustment of the seat surface SF is not possible. In this state, for example, the gas spring is only used for damping depending on a spring constant of the gas spring.

The gas spring device also has a fastener BM, which is firmly connected to the cylinder Z, for example. For example, the fastener BM can be ring-shaped and enclose the cylinder Z. Alternatively, the fastener BM can also have two or more elongated or rod-shaped individual components which are attached to the cylinder Z at different, in particular opposite-positions. If the cylinder Z moves along the longitudinal axis or if the cylinder Z rotates around the longitudinal axis of the gas spring, the fastener BM also moves along the longitudinal axis or rotates around the longitudinal axis accordingly.

The gas spring device also has an electronic circuit SK. The circuit SK, for example, can be located on or attached to the fastener BM, in particular. Circuit SK, for example, can contain a circuit board or printed circuit board on which electronic components and/or integrated circuits are arranged and, if necessary, interconnected. For example, the board can be attached to the fastener BM.

The gas spring device also has a force sensor KS, which is attached, for example, to the gas spring, especially to the piston K or to the housing G. In the example shown, the force sensor KS is attached to piston K. The force sensor KS, for example, can include a strain gauge that is attached to the piston K, for example. Alternatively, the force sensor KS can include a piezoelectric sensor, which is arranged, for example, on the piston K or between the piston K and the housing G. The force sensor KS is electrically connected to the circuit SK (connection not shown).

When a force acts on the gas spring in the direction of the longitudinal axis of the gas spring, for example because a user sits on the work chair BS, the force sensor KS detects the force acting in the direction of the longitudinal axis and generates a force signal depending on the force detected. The force sensor KS transmits the force signal to the circuit SK. For example, the circuit SK calculates weight data representing the body weight of the user of the work chair BS from the force signal.

The circuit SK also includes a communication interface, in particular an interface for wireless data transmission. The interface can be a Bluetooth interface, a WLAN interface, a GSM-based interface, a radio interface such as Zigbee, RF or RFID or another interface. For example, the circuit can transmit the weight data via the communication interface to an external receiver, such as another office equipment, a display device such as a smartphone or tablet computer, a computer or a server.

Optionally, the gas spring device has a deformation sensor, which in the example shown in FIG. 4 comprises a first deformation sensor element VS1 and a second deformation sensor element VS2. The deformation sensor elements VS1, VS2 are arranged on the cylinder Z, for example. The deformation sensor elements VS1, VS2 are strain gauges, for example. The deformation sensor elements VS1, VS2 are electrically connected to the circuit SK.

If the gas spring, in particular cylinder Z, is deformed, for example by a position of a center of gravity of the user of the work chair BS or a change in the position of the center of gravity, the deformation sensor elements VS1, VS2 detect a deformation of the gas spring, in particular of cylinder Z, for example by a different load on cylinder Z at the positions of the deformation sensor elements VS1, VS2. The deformation sensor, in particular the deformation sensor elements VS1, VS2, are designed to generate a deformation signal depending on the detected deformation and to transmit the deformation signal to the circuit SK. Depending on the deformation signal, especially depending on the deformation signal and the force signal, the circuit determines center of gravity data representing a position or a position of the center of gravity of the user of the office chair.

For example, the circuit SK is set up to transmit the center of gravity data to the external receiver via the communication interface.

In some embodiments, the circuit is set up to generate the center of gravity data depending on the deformation signal and the force signal.

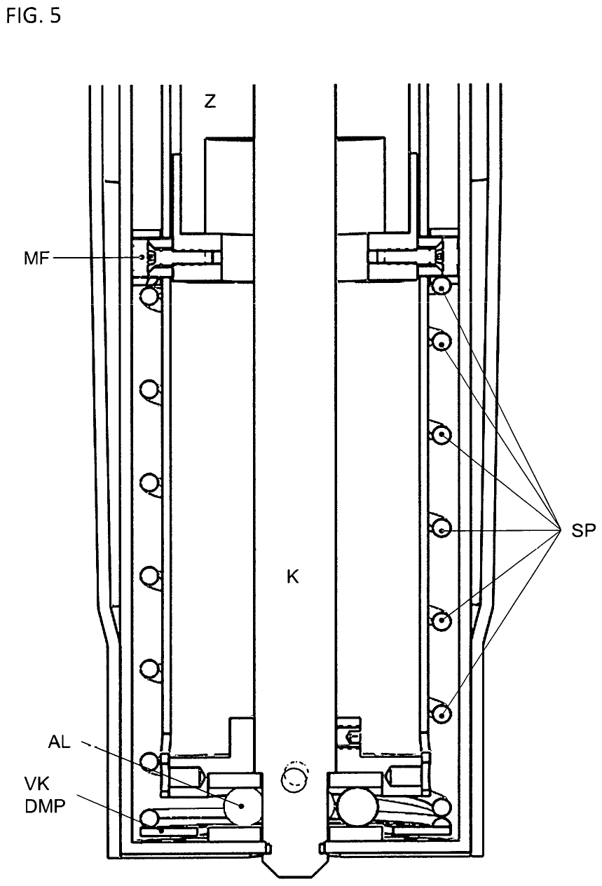

FIG. 5 shows an embodiment of a gas spring device which is designed for position measurement by means of mechanical integration. For this purpose, the gas spring device has a spiral spring SP inside the housing, which is arranged between a cam MF, which is attached to the cylinder Z, and a deformation body VK. For example, a deformation sensor is arranged as a force sensor on the deformation body VK and forms a measuring point DMP. The spiral spring SP is supported on the deformation body VK, so to say.

When the axial position of the cylinder is changed, the spiral spring SP is compressed or released. The axial position can be calculated by measuring the current load using the constant spring rate of the spiral spring SP. Other spring bodies can also be used instead of the spiral spring SP.

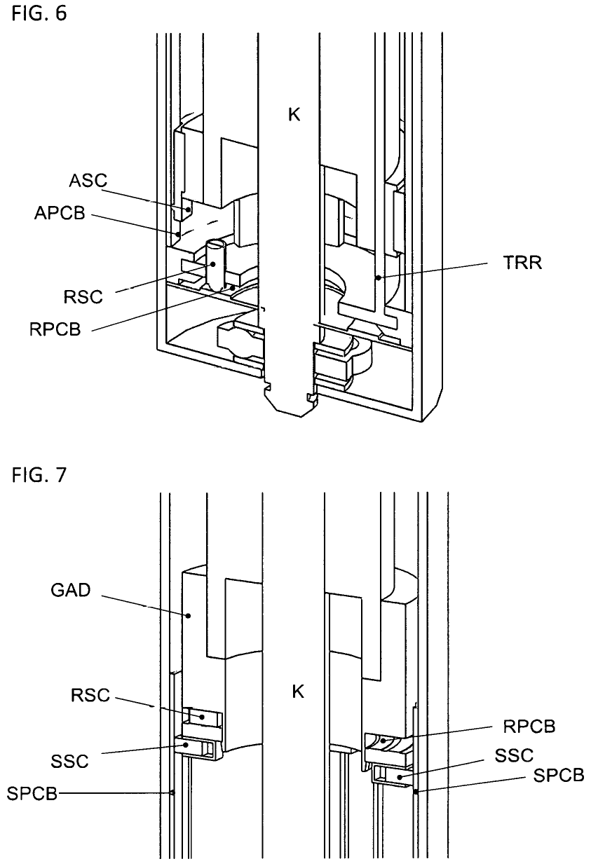

FIG. 6 shows another embodiment of a gas spring device for position measurement. In the example implementation shown, the position measurement is carried out by means of resistive measurements based on the principle of a potentiometer.

For example, an axial resistance path APCB is mounted on the inside of the housing, which extends essentially parallel to the longitudinal axis of the gas spring. An axial grinder ASC is provided, which is secured against rotation and attached to the axially displaceable cylinder. Shifting the slider ASC along the resistance path APCB results in a changing resistance from which the axial position can be determined.

The illustration also shows a radial resistance path RPCB with an associated radial grinder RSC. The grinder RSC is coupled to a driving tube TRR to transfer a rotary movement of the gas spring to the grinder RSC. The radial resistance path RPCB extends circularly or at least in the form of a circular segment around the longitudinal axis of the gas spring or piston K. The resulting resistance value from the combination of the radial resistance path RPCB and the radial grinder RSC can in turn be used to indicate a position, in this case an angular position.

The measured resistance values are processed, for example, in the circuit SK not shown here.

Although both axial position measurement and radial position measurement are shown in FIG. 6, it is of course possible to implement only one of the two measurements in different implementation forms.

In the design shown, a plate with the radial resistance paths RPCB is fixedly connected to the housing and in particular cannot be displaced in relation to the longitudinal axis in the housing.

FIG. 7 shows a further embodiment of a position sensor in a gas spring device based on the principle of a potentiometer, in which the radial resistance path RPCB is attached to the gas spring via an adapter GAD and can thus be displaced in relation to the longitudinal axis in the housing. In addition, the same measuring principle is used as described in FIG. 6. The axial measurement is not shown for overview purposes only, but can also be used here.

To transmit the signals from the moving part with the adapter GAD to the outside, i.e. to the inside of the housing, a conductive path SPCB is provided in the version shown, to which a non-rotatably arranged slider SSC belongs for signal transmission. In particular, the combination of conductive track SPCB and associated slider SSC is mounted on both sides in the embodiment shown. The conductive track SPCB also acts as an anti-rotation device for the adapter GAD.

The resistance paths can be printed circuit boards or PCBs, for example. This also applies to the path for signal transmission SPCB.

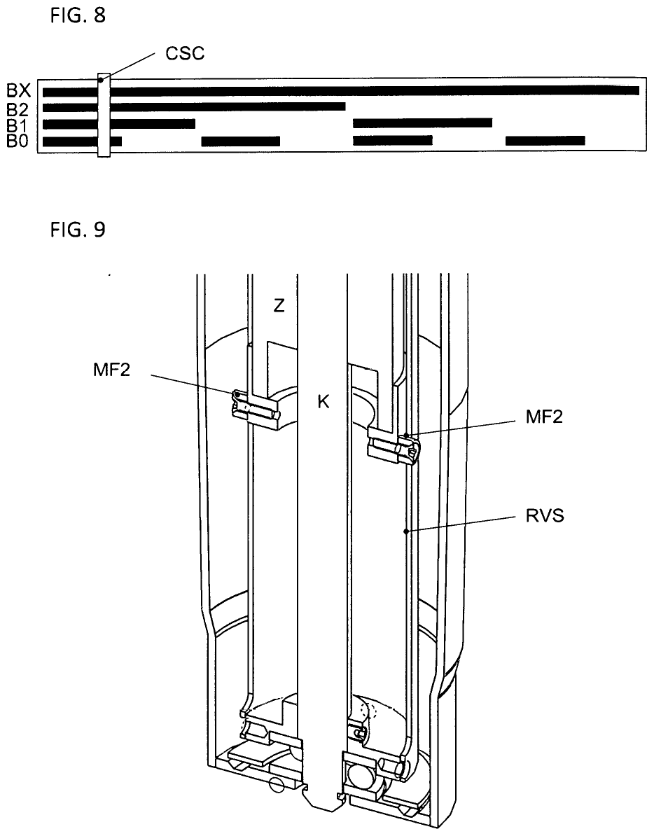

FIG. 8 shows another embodiment of a position sensor in which coded paths are provided instead of resistance paths, for example on a printed circuit board.

In the exemplary representation of FIG. 8, a first path BX is used for power supply, while paths B0, B1 and B2 are used for position coding. For this purpose, the respective paths B0, B1, B2 are divided into corresponding conductive and non-conductive areas according to a binary coding. A coding slider CSC moves when the gas spring device moves and contacts the individual paths B0, B1, B2 depending on the position, so that a position can be determined in a resolution corresponding to the number of paths. So in the example at hand with three tracks a resolution of 2\hat{ }3=8 positions results. This can be changed in a known way by adding further paths or by omitting paths.

The principle can be used for axial position measurement, whereby in principle reference is made to FIG. 6. However, the principle can also be used for radial position measurements, in which case the paths must again be arranged in a circle around the longitudinal axis or the piston. The mechanical requirements again result from the basic description of FIGS. 6 and 7.

FIG. 9 shows another embodiment of a gas spring device. In the version shown, the cylinder and the piston are connected to each other non-rotatably via a cam MF2 and an anti-rotation tube RVS.

This enables the measurement of a radial position at piston K. Such a measurement can be carried out, for example, via an arrangement with a magnet and one or more Hall sensors. Furthermore, it is possible to use a coded disk (not shown), which is arranged in connection with the piston K, for the measurement.

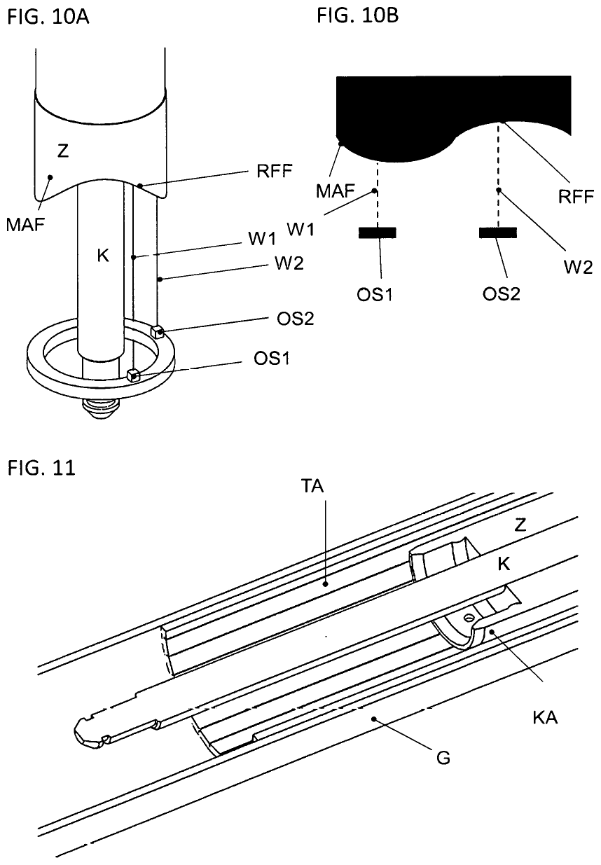

FIGS. 10A and 10B show an embodiment of a position measurement on the gas spring device based on a distance measurement. For this purpose, one end face of cylinder Z is designed as a reflector surface RFF. The reflector surface RFF has a defined varying extension over a circumference of cylinder Z in the direction of a longitudinal axis of the gas spring with respect to a normal extension to the longitudinal axis. While FIG. 10A shows a three-dimensional representation of the arrangement, FIG. 10B shows a lateral surface MAF of cylinder Z in the plane, i.e. unwound. For example, it can be seen that the reflector surface RFF extends essentially based on a sine curve.

The arrangement also has a first and a second distance sensor OS1, OS2, which measure a distance W1 or W2 to the reflector surface RFF. From the distances W1, W2 unique conclusions can be drawn about the position or location of the arrangement. For example, a unique angular position can be calculated by a difference of the two distances W1, W2. The axial position can be determined by averaging, or generally a sum of the distances W1, W2.

The distance sensors OS1, 0S2 can be designed as optical sensors based on infrared or laser radiation or as ultrasonic sensors.

FIG. 11 shows another type of gas spring device with a position sensor. In the design shown, conductive surfaces TA are attached to an inner side of the housing G as first, outer electrodes. Analogous to this, further conductive surfaces KA are provided on an outside of cylinder Z, which form second, inner electrodes. The first and second conductive surfaces TA, KA can also be formed directly through the inside of the housing G or the outside of the gas spring or the cylinder Z itself. Separate guide surfaces are therefore not absolutely necessary.

However, the surfaces TA, KA mentioned are not conductively connected to each other but are designed in such a way that they form a capacitive arrangement. When the cylinder moves in housing G, the overlapping surface between the electrodes TA, KA changes, resulting in a changed capacitance value. This can be evaluated, for example, by the electronics in the circuit SK, which it is not shown for overview reasons.

The linear reference allows direct conclusions to be drawn about the axial position from the determined capacity values.

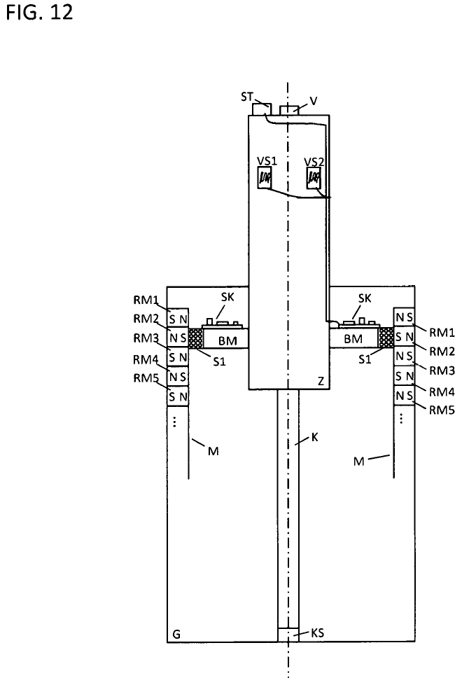

FIG. 12 shows another potential embodiment of the gas spring device, which is essentially based on the embodiment shown in FIG. 4.

The gas spring device in this embodiment optionally contains an energy harvesting device with an energy store (not shown), a coil S1 and a permanent magnet arrangement M. The energy store can be contained by the circuit SK or be arranged at another location of the gas spring device, for example in the housing G.

In the example in FIG. 12, coil S1 is arranged in a ring around the cylinder Z. So one or more windings of coil S1 run ring-shaped or essentially ring-shaped around cylinder Z. For example, the coil S1 is wound or arranged around the fastener BM. For example, a winding axis of coil S1 is parallel to or coincides with the longitudinal axis of the gas spring. Coil S1 is electrically connected to circuit SK.

The permanent magnet arrangement M in the gas spring device of FIG. 12, for example, is formed by an annular permanent magnet or a large number of annular permanent magnets RM1, RM2, RM3, RM4, RM5. It should be noted that the permanent magnet arrangement M comprises at least one annular permanent magnet. In particular, the number of ring-shaped permanent magnets is not necessarily equal to 5, as shown in FIG. 12. In addition, the permanent magnet arrangement M can also contain more than five annular permanent magnets, as indicated by the points in FIG. 12.

Each of the annular permanent magnets RM1, RM2, RM3, RM4, RM5 is radially magnetized. In particular, each of the annular permanent magnets RM1, RM2, RM3, RM4, RM5 has a north pole on an inner side, in particular a radial inner side, and a south pole on an outer side, in particular a radial outer side, or vice versa. The North and South poles are shown in FIG. 12 as N and S. The annular permanent magnets RM1, RM2, RM3, RM4, RM5 of the permanent magnet arrangement M, for example, are stacked one above the other along the longitudinal axis of the gas spring. Neighboring annular permanent magnets are magnetized in the opposite direction. For example, annular permanent magnets adjacent to an annular permanent magnet with a south pole on the inside and a north pole on the outside have a north pole on the inside and a south pole on the outside and vice versa.

Each of the annular permanent magnets RM1, RM2, RM3, RM4, RM5 has a symmetry axis which coincides with or substantially coincides with the longitudinal axis of the gas spring or runs parallel to the longitudinal axis of the gas spring. The annular permanent magnets RM1, RM2, RM3, RM4, RM5 are arranged around the cylinder Z, the fastening element BM and the coil S1. The annular permanent magnets RM1, RM2, RM3, RM4, RM5, for example, are mounted on an inner side of housing G.

The permanent magnet arrangement M generates an inhomogeneous magnetic flux density inside the annular permanent magnets RM1, RM2, RM3, RM4, RM5. The arrangement and orientation of the annular permanent magnets RM1, RM2, RM3, RM4, RM5 or their axis of symmetry and the arrangement or orientation of coil S1 generate a magnetic flux through coil S1. Due to the inhomogeneity of the magnetic flux density, the magnetic flux through coil S1 changes during movement of cylinder Z and thus of coil S1 along the longitudinal axis of the gas spring.

The changing magnetic flux through coil S1 induces a voltage in coil S1 by electromagnetic induction and generates a current in the coil based on the induced voltage, for example. The circuit SK is designed to tap the induced voltage and/or the generated current and thus charge the energy store. If necessary, the circuit SK may also be equipped to rectify the induced voltage or the current generated to charge the energy store by means of a rectifier circuit.

A power supply of the circuit SK, the force sensor KS, the deformation sensor, the communication interface and/or other elements of the gas spring device is thus possible by means of the energy harvesting device and the energy store.

In alternative embodiments, the energy harvesting device can contain the force sensor KS instead of or in addition to the coil S1 and the permanent magnet arrangement M, especially if the force sensor KS comprises a piezoelectric sensor. The energy store can then be charged, for example, by an electrical voltage generated by the piezoelectric sensor or a resulting current.

It should be noted that alternative embodiments of the gas spring device do not include the energy harvesting device. In such designs, for example, the circuit can be supplied with electrical energy via one or more batteries.

Alternative embodiments of the gas spring device do not include the force sensor KS and/or the deformation sensor.

In alternative embodiments, the housing G is not connected to the base FK, but to the seat surface SF, for example, while the piston K or the cylinder Z is connected to the base FK.

In alternative embodiments, not the cylinder Z of the gas spring is movable, but the piston K, while the cylinder Z is fixedly connected to the housing G along the longitudinal axis of the gas spring.

In alternative embodiments, the circuit SK is not arranged on the fastener BM, but for example at a different position in or on the housing G. Circuit SK for example can also be arranged outside of housing G.

In alternative embodiments, the permanent magnet arrangement M is connected to the cylinder Z and is moved along the longitudinal axis when the cylinder Z moves. In such designs, the coil S1 is not connected to the cylinder Z and is not moved along the longitudinal axis when the cylinder Z moves.

Optionally, the gas spring device has a plug connector ST, especially a plug or a socket. The connector ST, for example, can be connected to another corresponding connector of the office chair BS, which is arranged, for example, on the seat surface SF or the base FK. In addition, the connector ST is electrically connected to the circuit SK.

Via the connector, for example, data can be exchanged between the circuit SK and other electronic components of the office chair BS. In particular, data can be transferred from the other electronic components of the office chair to the circuit SK. The data transmitted from the other electronic components to the circuit SK, for example, can be transmitted via the communication interface of the circuit SK to the other external receiver.

The other electronic components can, for example, be supplied with electrical energy via the energy harvesting device and the plug connector ST. In designs that include both the connector ST and the energy harvesting device, the energy harvesting device can be used to supply power to the other electronic components.

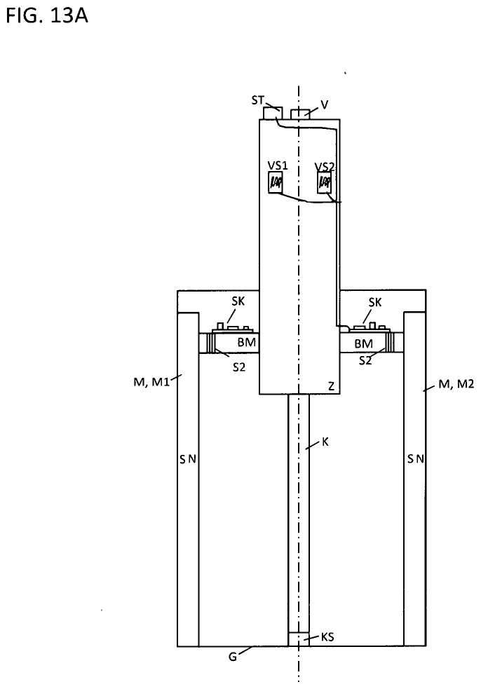

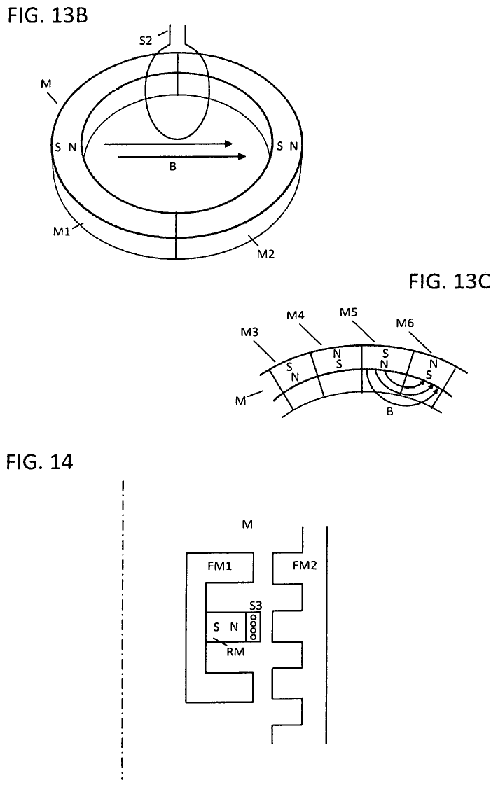

FIG. 13A shows another example embodiment of a gas spring device according to the improved concept. The gas spring device of FIG. 13A is based on the gas spring device of FIG. 4 or FIG. 12.

Differences between the gas spring device of FIG. 13A and the gas spring device of FIG. 4 or FIG. 12 concern, for example, only the energy harvesting device and possibly a shape of the fastener BM.

The energy harvesting device of the gas spring device of FIG. 13A contains a coil S2 whose windings run, for example, around a winding axis which lies in a plane which is perpendicular to the longitudinal axis of the gas spring. For this purpose, for example, the coil S2 can be arranged on the fastener BM. The fastener comprises, for example, at least one elongated component arranged on the cylinder L.

In the gas spring device of FIG. 13A, the permanent magnet arrangement M contains a first and a second permanent magnet M1, M2. The first permanent magnet M1, for example, is mounted on a first side of housing G, especially on an inner side of housing G. For example, the second permanent magnet M2 is mounted on a second side of housing G, especially on an inner side of housing G. The second side is opposite the first side. The first permanent magnet M1 has a south pole on one side facing housing G and the second permanent magnet M2 has a north pole on one side facing housing G. The first permanent magnet M1 has a north pole. Accordingly, the first permanent magnet M1 has a north pole on one side facing away from the housing G, i.e. towards the gas spring, while the second permanent magnet M2 has a south pole on one side facing away from the housing, i.e. towards the gas spring.

The arrangement of coil S2 or its orientation and the arrangement and orientation of the first and second permanent magnets M1, M2 generate a magnetic flux density which, depending on the position, especially the rotational position, generates a more or less large magnetic flux through coil S2. If the cylinder Z or the gas spring rotates around the longitudinal axis of the gas spring, for example caused by a rotation of the office chair or the seat surface SF, the coil S2 also rotates in this way. Consequently, an angle that includes the coil S2, in particular a winding plane or the winding axis of the coil S2, with a direction of magnetic flux density changes during rotation. As a result, the magnetic flux through coil S2 varies during the rotational movement around the longitudinal axis, which in turn leads to an induction voltage in coil S2. The induced voltage induces a current which is picked up by the circuit SK, rectified if necessary and used to charge the energy store.

With a gas spring device as in FIG. 13A, electrical energy can be harvested from a rotational movement of the seat surface and thus the energy store can be charged. It is pointed out that in other embodiments the energy harvesting devices of the gas spring devices as described and shown in FIGS. 12 and 13A, 13B and 13C can be combined at any time. This means that energy can be won and stored in the energy store both when the seat surface or gas spring rotates and when it moves along the longitudinal axis of the gas spring.

FIG. 13B shows an example implementation of a permanent magnet arrangement M for use in a gas spring device according to the improved concept, in particular a gas spring device as shown in FIG. 13A.

For example, the first magnet M1 is a semicircular magnet with radial magnetization, so that on the inside of the first magnet M1 there is a north pole and on the outside of the first magnet M2 there is a south pole. Correspondingly, the second permanent magnet M2 is also designed as a radially magnetized semicircular magnet. The second permanent magnet M2 has a south pole on one inside and a north pole on one outside. The first and second permanent magnets M1, M2 are arranged so that together they form a ring which is arranged around the coil S2 and the gas spring, as shown in FIG. 13A.

Just for clarification, a single winding of coil S2 and an exemplary direction of the magnetic flux density B are shown.

In alternative embodiments, the permanent magnet arrangement M can also be designed as a single diametrically polarized magnet. With such magnets, one half ring half represents a north pole and another half ring half a south pole.

FIG. 13C shows another example of a permanent magnet arrangement M for use in a gas spring device according to the improved concept, in particular a gas spring device as shown in FIG. 13A.

The permanent magnet arrangement M is annular (FIG. 13C shows only a partial segment of the permanent magnet arrangement M) and runs around the coil S2 and the gas spring, especially the cylinder Z. The permanent magnet arrangement M consists of permanent magnets M3, M4, M5, M6 arranged side by side, which for example have the form of ring segments. Adjacent ring segments correspond to alternately magnetized magnets, especially alternately radially magnetized magnets. Each ring segment M3, M4, M5, M6 has either a north pole on one side and a south pole on the outside or vice versa. Ring segments adjacent to a ring segment which has a south pole on the inside and a north pole on the outside have a north pole on the inside and a south pole on the outside and vice versa.

The magnetic flux density B runs in an arc on the inside of the permanent magnet arrangement M from the north poles of the ring segments to the south poles of the adjacent ring segments. This generates an inhomogeneous magnetic field inside the permanent magnet arrangement M. Consequently, the magnetic flux through coil S2 changes during a rotational movement of coil S2 around the longitudinal axis of the gas spring, which in turn leads to an induced voltage in coil S2. For the sake of clarity, the magnetic flux density B is shown as an example only between two ring segments M5, M5.

FIG. 14 shows another example implementation of a permanent magnet arrangement M for use in a gas spring device according to the improved concept. The permanent magnet arrangement M of FIG. 14, for example, can be used in a gas spring device as in FIG. 12 instead of or in addition to the permanent magnet arrangement shown and described there.

The permanent magnet arrangement M of FIG. 14 contains an annular permanent magnet RM, which is arranged around the gas spring, especially around the cylinder Z. The longitudinal axis of the gas spring is indicated in FIG. 14 by a semi-dot line. The permanent magnet arrangement M also has a first ferromagnetic element FM1, which has a U-shaped profile with an opening facing away from the gas spring or cylinder Z, respectively. The first ferromagnetic element FM1, for example, is rotationally symmetrical around the longitudinal axis of the gas spring and runs around the gas spring or around the cylinder Z. The annular permanent magnet RM is radially magnetized and has a south pole on a radial inner side and a north pole on a radial outer side or vice versa. The annular permanent magnet RM1 is connected to the first ferromagnetic element FM1, in particular magnetically conductive. For example, the annular permanent magnet RM1 is located inside the U-shaped profile of the first ferromagnetic element FM1.

The permanent magnet arrangement M also has a coil S3, which is arranged around the annular permanent magnet RM and is connected to it, for example. A winding axis of the coil S3 is parallel to the longitudinal axis of the gas spring and/or to the symmetry axis of the annular permanent magnet RM.

For example, the first ferromagnetic element FM1 is connected to the cylinder Z of the gas spring, so that when the cylinder Z moves along the longitudinal axis of the gas spring, the first ferromagnetic element FM1, the annular permanent magnet RM and the coil S3 also move along the longitudinal axis of the gas spring.

The permanent magnet arrangement M also has a second ferromagnetic element FM2, which is not moved along the longitudinal axis of the gas spring when the cylinder Z moves and is connected, for example, to the housing G of the gas spring device. The second ferromagnetic element FM2, for example, is arranged rotationally symmetrically around the gas spring, for example on an inner side of housing G. The second ferromagnetic element FM2 has a stepped profile. In particular, the second ferromagnetic element FM2 has first regions which have a first distance, in particular a first radial distance, from an axis of symmetry of the second ferromagnetic element FM2 and second regions which have a second distance, in particular a second radial distance, from the axis of symmetry of the second ferromagnetic element FM2. The second distance is greater than the first distance.

When the cylinder Z, the first ferromagnetic element FM1, the annular magnet RM and the coil S3 move along the longitudinal axis of the gas spring, the magnetic flux density at one position of the coil S3 varies through a changing flux density guidance due to the first and second ferromagnetic elements FM1, FM2, the U-shaped profile of the first ferromagnetic element FM1 and the stepped profile of the second ferromagnetic element FM2.

This causes a magnetic flux through the coil S3 to change during movement along the longitudinal axis, resulting in an electromagnetically induced voltage in the coil S3.

For example, the first and/or second ferromagnetic elements FM1, FM2 contain iron or another ferromagnetic material.

In alternative embodiments, the second ferromagnetic element FM2 is connected to the cylinder Z and is moved along the longitudinal axis. Then the first ferromagnetic element FM1, the annular permanent magnet RM and the coil S3 are not connected to the cylinder Z and are therefore not moved along the longitudinal axis.

The different aspects and components of the gas spring device or the office chair BS according to the improved concept described here can be combined depending on the specific application.

With an office chair BS according to the improved concept, it is possible to record user data such as the weight data, the center of gravity data, the other weight data, the height data and/or the other height data and to transmit them to an external receiver, for example to evaluate the user data, using the circuit SK. The evaluated user data can serve, for example, as a basis for instructions to the user of the office chair BS. In this way, the usage behavior of the user of the BS office chair can be improved.

By arranging the at least one sensor element, the circuit SK and, if necessary, the energy harvesting device in or on the gas spring device, a particularly efficient and flexible solution is achieved. In particular, the gas spring device is easy to replace, so that, for example, conventional office chairs can also be equipped with a gas spring device of an office chair BS according to the improved concept.

### REFERENCE SIGNS

BS office chair
SF seat surface
RL backrest
FK base
G housing
Z cylinder
K piston
SK electronic circuit
KON cone
KS force sensor
VS1, VS2 deformation sensor elements
BM fastener
V adjustment element
ST connectors
S1, S2, S3 coils
M permanent magnet arrangement
RM1, RM2, RM3, permanent magnets
RM4, RM5, RM, M1, permanent magnets
M2, M3, M4, M5, M6 permanent magnets
S South pole
N North pole
B magnetic flux density
FM1, FM2 ferromagnetic elements
SSC, RSC, ASC grinders
SPCB, RPCB, APCB path
GAD adapter
OS1, OS2 distance sensor
EG electronic housing
AL thrust bearing
MF, MF2 cam

1. A gas spring device for adjusting the height of an office chair, the gas spring device comprising
a gas spring, arranged and equipped for height adjustment of the office chair by means of a movable component of the gas spring,
at least one sensor element arranged on the gas spring device, configured to detect a load on the gas spring device and to generate at least one sensor signal depending on the detected load, and
an electronic circuit arranged to generate usage data depending on the at least one sensor signal, the usage data representing one or more facts about a usage of the office chair; wherein
the at least one sensor element comprises at least one position sensor which is adapted to detect a position of the movable component and to generate a position signal dependent on the detected position.

2. The gas spring device according to claim 1,
further comprising a spring body arranged between a part of the movable component and a force sensor enclosed by the position sensor, wherein
the force sensor is configured to detect a force acting from the spring body on the force sensor in the direction of a longitudinal axis of the gas spring and to generate a force signal depending on the detected force, and
the circuit is configured to generate the position signal depending on the force signal.

3. The gas spring device according to claim 2,
wherein the force sensor comprises a deformation body on which the spring body is supported, and wherein at least one deformation sensor is attached to the deformation body and is adapted to generate the force signal as a function of a detected deformation of the deformation body.

4. The gas spring device according to claim 2,
wherein the spring body comprises a spiral spring.

5. The gas spring device according to claim 1, wherein the circuit is adapted to generate height data representing a height adjustment of the office chair as a function of the position signal.

6. The gas spring device according to claim 1, wherein the circuit is configured,
to determine, based on a change in the position signal and on a spring constant of the gas spring, a force which acts on the gas spring in the direction of a longitudinal axis of the gas spring, and
to generate second additional weight data representing the body weight of a user of the office chair, depending on the determined force.

7. The gas spring device according to claim 1, wherein the position sensor comprises at least one combination of at least one conductive surface and an associated slider formed between a fixed part of the gas spring device and the movable component.

8. The gas spring device according to claim 7,
wherein the combination comprises at least one potentiometer with a resistive surface as the conductive surface and with the associated slider, and wherein the circuit is configured to generate the position signal depending on a resistance of the at least one potentiometer.

9. The gas spring device according to claim 8,
wherein the at least one potentiometer is formed parallel to a longitudinal axis of the gas spring and is disposed between an inside of a housing of the gas spring device and the movable component, and wherein the position signal comprises an axial position.

10. The gas spring device according to claim 8,
wherein the at least one potentiometer is designed as an angular potentiometer which is formed circularly to a longitudinal axis of the gas spring with a circular or circular segment shaped resistive surface and with the associated slider, wherein either said resistive surface or the associated slider is arranged rotationally fixed with respect to a housing of the gas spring device, and wherein the position signal comprises a radial position.

11. The gas spring device according to claim 10,
wherein the rotationally fixed part of the angular potentiometer is not displaceable with respect to the longitudinal axis in the housing.

12. The gas spring device according to claim 10,
wherein the rotationally fixed part of the angular potentiometer is displaceable with respect to the longitudinal axis in the housing.

13. The gas spring device according to claim 12,
wherein the position sensor comprises a further combination of a further conductive surface and an associated slider, and wherein the further combination is configured to transmit the position signal.

14. The gas spring device according to claim 10, wherein the position sensor comprises an element, in particular a tube, for transferring a rotational movement of the gas spring to either the resistive surface of the angular potentiometer or the associated slider.

15. The gas spring device according to claim 7, wherein the combination comprises at least one path having at least one conductive surface and at least one non-conductive surface for binary coding, wherein a slider is associated with each path, and wherein the circuit is arranged to generate the position signal in dependence on a conductivity between the at least one path and the associated slider.

16. The gas spring device according to claim 15,
wherein the at least one path is arranged parallel to a longitudinal axis of the gas spring, and wherein the position signal comprises an axial position.

17. The gas spring device according to claim 15,
wherein the at least one path is circular to a longitudinal axis of the gas spring having a circular or circular segment shape, wherein either the at least one path or the associated slider is arranged rotationally fixed with respect to a housing of the gas spring device, and wherein the position signal comprises a radial position.

18. The gas spring device according to claim 1, wherein the movable component comprises a piston and a cylinder longitudinally displaceable therein, which are rotationally coupled to each other, wherein the position sensor comprises an angle sensor which detects an angular position of the cylinder, and wherein the position signal comprises a radial position.

19. The gas spring device according to claim 18,
wherein the angle sensor comprises a coding disc or a magnet with at least one Hall sensor, in particular at least two Hall sensors.

20. The gas spring device according to claim 1, wherein
the movable component comprises a piston and a cylinder longitudinally displaceable therein,
an end face of the cylinder forms a reflector surface,
the reflector surface has a defined varying extent over a circumference of the cylinder in the direction of a longitudinal axis of the gas spring with respect to a normal to the longitudinal axis,
the position sensor comprises a first and an at least second distance sensor fixedly mounted in a housing of the gas spring device and configured to detect a first and second distance to the reflector surface, and
the circuit is configured to generate the position signal as a function of the first and second distances.

21. The gas spring device according to claim 20, wherein the defined varying extent is based on a sine curve.

22. The gas spring device according to claim 20, wherein the circuit is configured to generate the position signal
with an axial position, based on a sum of the first and second distances, and/or
with a radial position, based on a difference of the first and second distances.

23. The gas spring device according to claim 1, wherein the position sensor is configured to determine a resonance frequency of a vacant space in a housing of the gas spring device to the movable component, wherein the circuit is configured to generate the position signal as a function of the determined resonance frequency, and wherein the position signal comprises an axial position.

24. The gas spring device according to claim 1, wherein the position sensor comprises a first conductive surface formed on an inside of a housing of the gas spring device and a second conductive surface formed on an outside of the movable component in the housing, wherein a capacitive arrangement is formed by the first and second conductive surfaces, wherein the circuit is configured to generate the position signal in dependence on a capacitance value of the capacitive arrangement, and wherein the position signal comprises an axial position.

25. The gas spring device according to claim 1, wherein
the gas spring device comprises an energy harvesting device with at least one coil and at least one permanent magnet, which is arranged to harvest electrical energy from a movement of the movable component,
the circuit is connected to the energy harvesting device to supply power to the circuit,
the at least one coil or the at least one permanent magnet is attached to the movable component,
the at least one sensor element comprises at least one further position sensor which is configured to detect a position of the movable component based on a spatial inhomogeneity of a magnetic flux density generated by the at least one permanent magnet and to generate a further position signal depending on the detected position, and
the circuit is configured to generate further height data representing a height setting of the office chair depending on the further position signal.

26. The gas spring device according to claim 1, wherein the circuit comprises a communication interface configured for wireless transmission of the usage data to at least one external receiver.

27. The gas spring device according to claim 26, wherein the communication interface is adapted to transmit the usage data via Bluetooth, WLAN, Zigbee, RF, RFID or a GSM-based technology.

28. The gas spring device according to claim 26, wherein the external receiver is formed as a smartphone or tablet computer.

29. The gas spring device according to claim 1, further comprising a plug connector for a plug connection adapted to electrically connect the gas spring device to other electronic components of the office chair.
